(19) United States
(12) Patent Application Publication
(10) Pub. No.: US 2024/0144038 A1
(43) Pub. Date: May 2, 2024

(54) FINDING SHORT COUNTERFACTUALS

(71) Applicant: Intuit Inc., Mountain View, CA (US)

(72) Inventors: Omer ZALMANSON, Petah Tikva (IL); Aviv BEN ARIE, Ramat Gan (IL)

(21) Appl. No.: 17/978,015

(22) Filed: Oct. 31, 2022

(51) Int. Cl. G06N 5/02; G06N 5/04

(52) U.S. Cl. CPC G06N 5/022; G06N 5/04

(57) ABSTRACT

A method finds short counterfactuals. The method includes receiving an input vector with a plurality of input features. The method further includes processing, with a model, the input vector to generate a score. The score of the input vector is not to a selected class. The method further includes searching for a counterfactual vector using a cost value and a heuristic value. The searching includes replacing one or more input features of the input vector with one or more counterfactual features to generate the counterfactual vector. The counterfactual vector corresponds to a counterfactual score to the selected class. The method further includes presenting one or more recommendations using the counterfactual vector.

### BACKGROUND

Computer implemented models, including machine learning models, are becoming increasingly complex to solve increasingly sophisticated problems. With increased complexity, the explainability of the operation of such models reduces. A way analyze and explain the operation of a model is to generate a counterfactual for a given input that generates a different output from the model. A challenge is to determine a counterfactual that has minimal changes for a given input to a model.

### SUMMARY

In general, in one or more aspects, the disclosure relates to a method that finds short counterfactuals. The method includes receiving an input vector with a plurality of input features. The method further includes processing, with a model, the input vector to generate a score. The score of the input vector is not to a selected class. The method further includes searching for a counterfactual vector using a cost value and a heuristic value. The searching includes replacing one or more input features of the input vector with one or more counterfactual features to generate the counterfactual vector. The counterfactual vector corresponds to a counterfactual score to the selected class. The method further includes presenting one or more recommendations using the counterfactual vector.

In general, in one or more aspects, the disclosure relates to a system that finds short counterfactuals. The system includes a counterfactual controller configured to search for a counterfactual vector, a recommendation controller configured to present one or more recommendations, and an application executing on one or more servers. The application is configured for receiving an input vector with a plurality of input features. The application is further configured for processing, with a model, the input vector to generate a score. The score of the input vector is not to a selected class. The application is further configured for searching, using the counterfactual controller, for the counterfactual vector using a cost value and a heuristic value. The searching includes replacing one or more input features of the input vector with one or more counterfactual features to generate the counterfactual vector. The counterfactual vector corresponds to a counterfactual score to the selected class. The application is further configured for presenting, with the recommendation controller, the one or more recommendations using the counterfactual vector.

In general, in one or more aspects, the disclosure relates to a method that uses counterfactuals. The method includes transmitting a request. The method further includes receiving a response to the request. The response is generated by: processing, with a model, an input vector to generate a score; searching for a counterfactual vector using a cost value and a heuristic value; and presenting one or more recommendations using the counterfactual vector. The method further includes displaying the response with the one or more recommendations.

Other aspects of the invention will be apparent from the following description and the appended claims.

### BRIEF DESCRIPTION OF DRAWINGS

FIG. 1A and FIG. 1B show diagrams of systems in accordance with disclosed embodiments.

FIG. 2 shows a flowchart in accordance with disclosed embodiments.

FIG. 3 and FIG. 4 show examples in accordance with disclosed embodiments.

FIG. 5A and FIG. 5B show computing systems in accordance with disclosed embodiments.

### DETAILED DESCRIPTION

In general, embodiments are directed to finding short counterfactuals that may be used to explain the output of a computational model to provide.

A counterfactual is a value that generates a different input with the model as compared to an original input. The counterfactual may use the same features from the input and may replace one or more of the original input features with counterfactual features. The counterfactual features may be a mean for numerical features and a mode for categorical features.

In one example, Wonder Woman may ponder why her selfie image did not generate as many clicks as she had expected. The selfie image may be processed to extract an input vector that is processed with a model that scores the image based on the input vector. The score for the image (i.e., the output of the model) may indicate that the image is not to a selected class since the objective quality of the image is below a threshold. The system generates a counterfactual vector by replacing features in the input vector with counterfactual features. When processed by the model, the counterfactual vector generates an output that is to the selected class and is above the threshold. Recommendations can then be made based on the changes that were made to the input vector in order to generate the counterfactual vector.

As another example, Spiderman may ponder why his loan application did not get accepted. An input vector generated from his application information may have been processed by a computer implemented computational model to generate a score that does not meet a threshold and does not provide a reason why. The system generates a counterfactual vector from the input vector and then generates recommendations for improving the application based on the changes made to the input vector to make the counterfactual vector.

The figures of the disclosure show diagrams of embodiments that are in accordance with the disclosure. The embodiments of the figures may be combined and may include or be included within the features and embodiments described in the other figures of the application. The features and elements of the figures are, individually and as a combination, improvements to the technology of computer implemented models and counterfactual generation. The various elements, systems, components, and steps shown in the figures may be omitted, repeated, combined, and/or altered as shown from the figures. Accordingly, the scope of the present disclosure should not be considered limited to the specific arrangements shown in the figures.

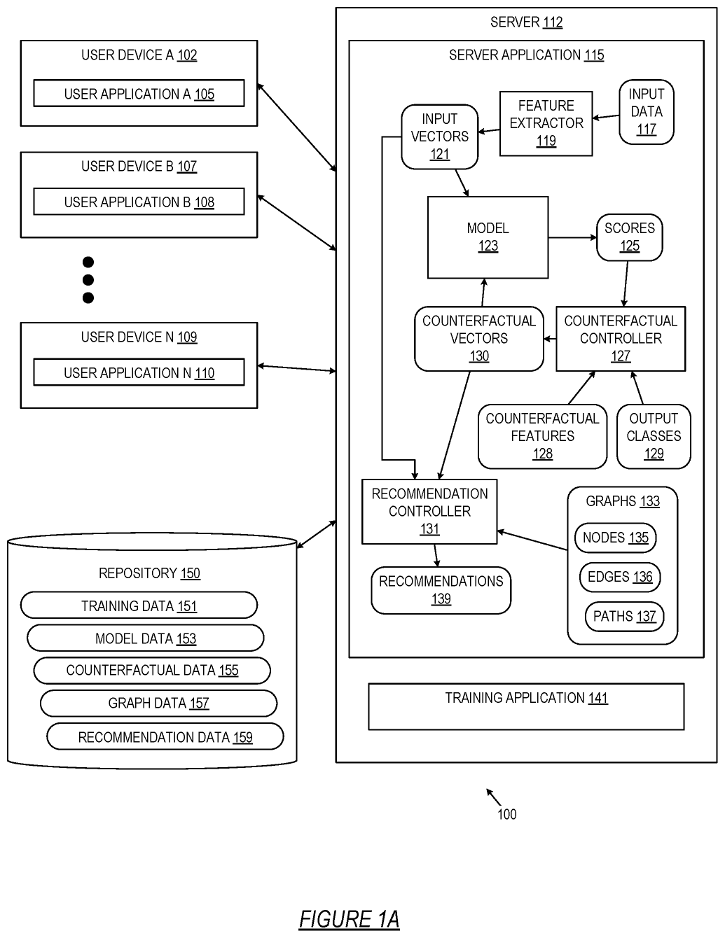

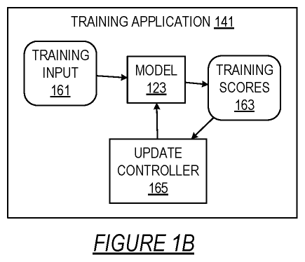

Turning to FIG. 1A, the system (100) finds short counterfactuals. The system (100) processes input from the user devices A (102) and B (107) through N (109) with the server (112) to generate the recommendations (139). The system (100) includes the server (112), the user devices A (102) and B (107) through N (109), and the repository (150).

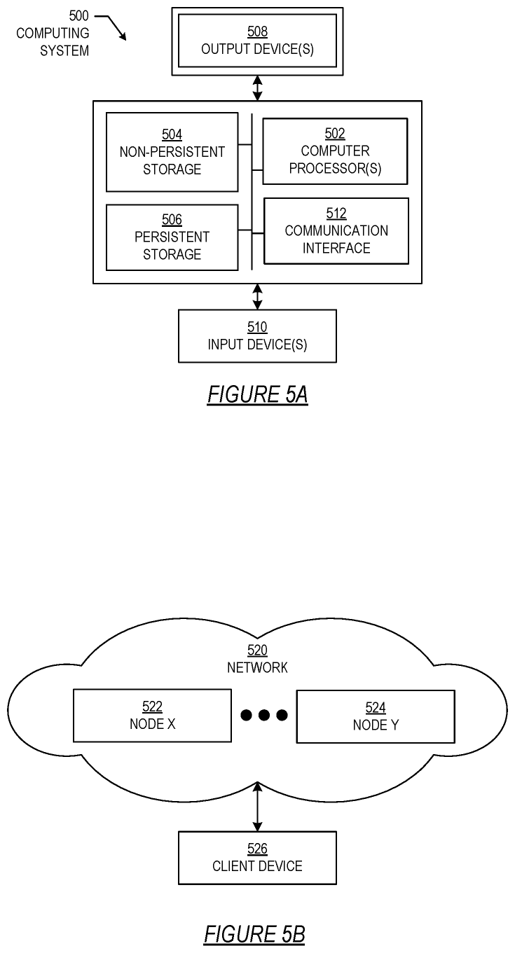

The server (112) is a computing system (further described in FIG. 5A). The server (112) may include multiple physical and virtual computing systems that form part of a cloud computing environment. In one embodiment, execution of the instructions, programs, and applications of the server (112) is distributed to multiple physical and virtual computing systems in the cloud computing environment. The server (112) includes the server application (115).

The server application (115) is a collection of programs with instructions that may execute on multiple servers of a cloud environment, including the server (112). The server application (115) processes the input data (117) to generate the scores (125), processes the scores (125) to generate the counterfactual vectors (130), and processes the counterfactual vectors (130) to generate the recommendations (139). In one embodiment, the server application (115) hosts websites and may serve structured documents (hypertext markup language (HTML) pages, extensible markup language (XML) pages, JavaScript object notation (JSON) files and messages, etc.) to interact with the user devices A (102) and B (107) through N (109) to receive the input data (117) and present the recommendations (139). The server application (115) includes the feature extractor (119), the model (123), the counterfactual controller (127), and the recommendation controller (131).

The input data (117) is data from the user devices A (102) and B (107) through N (109) that are processed by the model (123). The input data (117) corresponds to the model (123). In one embodiment, the input data (117) is image data (pictures, photos, images, etc.) that is processed by the model (123). In one embodiment, the input data (117) is financial data (records of financial transactions, records of accounts, etc.).

The feature extractor (119) is a collection of programs with instructions that may operate on the server (112). The feature extractor (119) processes the input data (117) to generate the input vectors (121). The feature extractor (119) may use multiple numerical transformations and algorithms to extract input features from the input data (117). In one embodiment, the feature extractor (119) may include machine learning models that extract input features from the input data (117). A set of input features extracted from the input data (117) forms one of the input vectors (121).

The input vectors (121) are sets of input features extracted from the input data (117). In one embodiment, the input data (117) includes images and the input vectors (121) include image features extracted from the image data. The image features may include size, resolution, brightness, clarity, sharpness, saturation, hue, luminosity, image classification, etc. In one embodiment, the input data (117) includes financial data and the input vectors (121) include financial features extracted from the financial data. The financial features may include records of transactions, statistical attributes (e.g., mean transaction value, mode of transaction type, etc.), account balances, etc.

Different input features may represent different attributes of an input. With an image as an input, the attributes represented by input features may include size, resolution, brightness, clarity, sharpness, saturation, hue, luminosity, image classification, etc. With financial data as an input, attributes represented by input features may include transaction information, statistical attributes (e.g., mean transaction value, mode of transaction type, etc.), account balances, etc. The order and type of input features may be the same between different input vectors.

The model (123) is a collection of programs with instructions that may operate on the server (112). The model (123) processes the input vectors (121) and may process the counterfactual vectors (130) to generate the scores (125). One of the input vectors (121) corresponds to one of the scores (125) and one of the counterfactual vectors (130) corresponds to a different one of the scores (125). The model (123) may be a machine learning model. In one embodiment, the model (123) may include a neural network that processes the input vectors (121) using neural network algorithms (convolutional algorithms, transformer algorithms, attention algorithms, recurrent algorithms, etc.).

The scores (125) are the outputs of the model (123). The scores (125) may be scaler values, vectors of scaler values, etc. In one embodiment, a score may be a scaler value that is a prediction of the number of clicks an image may generate on a social media website. In one embodiment, a score may be a scaler value that is a probability of repayment.

The counterfactual controller (127) is a collection of programs with instructions that may operate on the server (112). The counterfactual controller (127) processes the scores (125) with the counterfactual features (128) and the output classes (129) to generate the counterfactual vectors (130). The counterfactual controller (127) replaces input features of the input vectors (121) with the counterfactual features (128) to generate the counterfactual vectors (130) based on the output classes (129). The counterfactual controller (127) minimizes the number of replacements of input features by the counterfactual features (128).

The counterfactual features (128) are numerical features that replace input features of the input vectors (121). For an input feature of an input vector, a counterfactual feature replaces the input feature to form a counterfactual vector. By changing the input features of an input vector, a counterfactual vector will have a different score when processed by the model (123).

The output classes (129) are the classifications of the scores (125). In one embodiment, a threshold may be used to define the output classes (129). Scores that satisfy the threshold may be to a selected class. Other scores that do not satisfy the threshold are to another class and are not to the selected class. When an input vector generates a score that is not to a selected class (e.g., below a threshold), the system (100) generates a counterfactual vector that replaces enough of the input features of the input vector so that the score of the counterfactual vector is to the selected class (e.g., above the threshold). Multiple thresholds and additional algorithms may be used to identify and define the output classes (129).

The counterfactual vectors (130) are modified versions of the input vectors (121). The counterfactual vectors (130) are modified to replace one or more input features of the input vectors (121) with the counterfactual features (128). The scores (125) for the counterfactual vectors (130) are to a different one of the output classes (129) as compared to the input vectors (121).

For example, an input vector may have a score that is below a threshold and a counterfactual vector generated from the input vector (by replacing one or more of the input features with counterfactual features) may have a score that is above the threshold. With the score of the input vector below the threshold, the input vector is not part of the selected class. With the score of the counterfactual vector above the threshold, the counterfactual vector is part of the selected class.

The recommendation controller (131) is a collection of programs with instructions that may operate on the server (112). The recommendation controller (131) processes the counterfactual vectors (130) to generate the recommendations (139). In one embodiment, the recommendation controller (131) uses the graphs (133) to process the counterfactual vectors (130). In one embodiment, the recommendation controller (131) identifies the changes made to one of the input vectors (121) to generate one of the counterfactual vectors (130). The changes, which include the replacement of input features of an input vector with counterfactual features, may be recorded with the paths (137).

The graphs (133) are data structures that record changes between the input vectors (121) and the counterfactual vectors (130). The graphs (133) include the nodes (135), the edges (136), and the paths (137).

The nodes (135) are elements of the graphs (133). Each graph may have multiple nodes. A root node (i.e., a node with no parent node) may correspond to an input vector that corresponds to a score that is not to a selected class. A leaf node (i.e., node with no child nodes) may represent a counterfactual vector that corresponds to a score that is to a selected class. In one embodiment, nodes that are not a root of a graph are intermediate nodes. The intermediate nodes represent intermediate vectors that include one or more counterfactual features replacing input features from the input vector. An intermediate node, like the root node, may not correspond to a score that is to a selected class. When an intermediate vector of an intermediate node corresponds to a score to the selected class, the intermediate vector is a counterfactual vector.

The edges (136) connect between the nodes (135). An edge identifies an input feature, from an input vector, that is changed to a counterfactual feature.

The paths (137) are sequences of nodes and edges. The paths (137) identify which input features are replaced with counterfactual features and identify the order in which the replacements are made. Replacements with the largest impact on the score may be represented by edges that occur closer to a root node than to a leaf node.

The recommendations (139) identify changes that may be made to the input features of the input vectors (121). A subsequent input that includes the changes may correspond to a score that is within a selected class. The recommendations (139) are presented to the user devices A (102) and B (107) through N (109) so that a user may update inputs to the system (100).

The training application (141) is a collection of programs with instructions that may execute on multiple servers of a cloud environment, including the server (112). The training application (141) trains the model (123), an embodiment of which is further described with FIG. 1B.

Continuing with FIG. 1A, the user devices A (102) and B (107) through N (109) are computing systems (further described in FIG. 5A). For example, the user devices A (102) and B (107) through N (109) may be desktop computers, mobile devices, laptop computers, tablet computers, server computers, etc. The user devices A (102) and B (107) through N (109) include hardware components and software components that operate as part of the system (100). The user devices A (102) and B (107) through N (109) communicate with the server (112) to access, manipulate, and view services and information hosted by the system (100). The user devices A (102) and B (107) through N (109) may communicate with the server (112) using standard protocols and file types, which may include hypertext transfer protocol (HTTP), HTTP secure (HTTPS), transmission control protocol (TCP), internet protocol (IP), hypertext markup language (HTML), extensible markup language (XML), etc. The user devices A (102) and B (107) through N (109) respectively include the user applications A (105) and B (108) through N (110).

The user applications A (105) and B (108) through N (110) may each include multiple programs respectively running on the user devices A (102) and B (107) through N (109). The user applications A (105) and B (108) through N (110) may be native applications, web applications, embedded applications, etc. In one embodiment, the user applications A (105) and B (108) through N (110) include web browser programs that display web pages from the server (112).

As an example, the user application A (105) may be used to generate an input that forms part of the input data (117). The input is processed by the system (100) to generate one of the recommendations (139). The recommendation may be presented to and displayed by the user application A (105).

The repository (150) is a computing system that may include multiple computing devices in accordance with the computing system (500) and the nodes (522) and (524) described below in FIGS. 5A and 5B. The repository (150) may be hosted by a cloud services provider that also hosts the server (112). The cloud services provider may provide hosting, virtualization, and data storage services as well as other cloud services to operate and control the data, programs, and applications that store and retrieve data from the repository (150). The data in the repository (150) includes the training data (151), the model data (153), the counterfactual data (155), the graph data (157), and the recommendation data (159).

The training data (151) is data used to train the model (123). In one embodiment, the training data (151) includes historical inputs and corresponding scores that are used to improve the model (123).

The model data (153) is data that defines the model (123). The model data (153) may include parameters, weights, hyperparameters, etc.

The counterfactual data (155) is data that includes the counterfactual features (128). In one embodiment, the counterfactual data (155) includes means and averages for input features from the historical inputs from the training data (151).

The graph data (157) is data for the graphs (133). A graph may be generated for each pair of an input vector and a counterfactual vector.

The recommendation data (159) is data included in the recommendations (139) that are presented to the user devices A (102) and B (107) through N (109). The recommendation data (159) may include text descriptions of adjustments that may be made to input to the system (100) to achieve a result, i.e., to have an input generate a score to a selected class.

Although shown using distributed computing architectures and systems, other architectures and systems may be used. In one embodiment, the server application (115) may be part of a monolithic application that implements the modeling and management of affinity networks. In one embodiment, the user applications A (105) and B (108) through N (110) may be part of monolithic applications that implement and use affinity networks without the server application (115).

Turning to FIG. 1B, the training application (141) is a collection of programs with instructions that may execute on multiple servers of a cloud environment, including the server (112) of FIG. 1A. The training application (141) trains the model (123) using the update controller (165) to improve the model (123).

The training input (161) is the input used to train the model (123). The training input (161) may be a subset of the training data (151). The training input (161) may include training input vectors that are input to the model (123).

The model (123) is the computational model being trained. The model (123) is used by the server application (115) to generate the scores (125). The model (123) processes the training input (161) to generate the training scores (163).

The training scores (163) are the outputs of the model (123). In one embodiment, one training score may be generated for each training input.

The update controller (165) updates the model (123). In one embodiment, the update controller (165) processes the training scores (163) to generate updates for the model (123). One or more algorithms may be used by the update controller (165), including backpropagation, gradient descent, boosting, gradient boosting, etc.

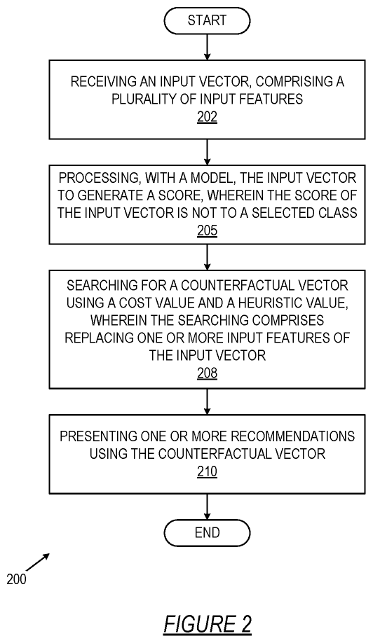

Turning to FIG. 2, the process (200) uses counterfactual vectors. The process (200) may be performed by a computing device interacting with one or more additional computing devices. For example, the process (200) may execute on a server response to one or more user devices.

At Step 202, an input vector is received. The input vector may include multiple input features.

In one embodiment, the input features of an input vector are extracted from an input received by the system. The input may be received by the system in response to a user accessing a website to provide the input. In one embodiment, the input may be an image. In one embodiment, the input may be financial data.

At Step 205, the input vector is processed with a model to generate a score. The score of the input vector may not be to a selected class. In one embodiment, the model may be a machine learning model. In one embodiment, the model may include a neural network. The model may utilize multiple data transformations to generate the score from the input vector. In one embodiment, the score is a scalar value. In one embodiment, the score is a vector of scalar values.

In one embodiment, the input vector is processed with a model using a machine learning algorithm. The model processes training input to generate training output and processing the training output to update the model to improve a characteristic of the model. The characteristic may be the accuracy of the model. Algorithms may use backpropagation, gradient descent, boosting, gradient boosting, etc.

At Step 208, a counterfactual vector is searched for using a cost value and a heuristic value. The searching includes replacing one or more input features of the input vector with one or more counterfactual features to generate the counterfactual vector. The counterfactual vector corresponds to a counterfactual score to the selected class. In one embodiment, the counterfactual vector is searched for using the A* search algorithm.

In one embodiment, the cost value is determined by identifying the number of changes between an input vector and a counterfactual vector. For example, an input vector with seven input features may have three of the input features changed to counterfactual features. With three of the input vectors being changed, the cost value is three.

In one embodiment, the heuristic value is determined using an intermediate vector. In one embodiment, Equation 1 may be used.

$$( \frac{lambda * depth}{num\_features} ) ( \frac{\vert goal\_score - current\_score \vert}{current\_delta} ) \qquad Eq . 1$$

The value “lambda” is a hyperparameter with a range of [0, 1]. The value “lambda” may be set by a developer of the system.

The value “depth” is the number of features in the intermediate vector that have been changed from input features to counterfactual features. The value “depth” may correspond to the number of edges between the current intermediate node and the root node of a graph used to search for counterfactual vectors.

The value “num_features” is the total number of features in the vectors used by the system. The total number of features may also be referred to as the number of dimensions and is the same for the input vector, intermediate vectors, counterfactual vector, etc.

The value “goal_score” is the score attempting to be achieved. The value “goal_score” is a score that is within the selected class. For example, the “goal_score” may satisfy a threshold by being above the threshold value.

The value “current_score” is the score of the current intermediate vector being processed. If the “current_score” had satisfied the “goal_score”, then the algorithm would have stopped and identified the current intermediate vector corresponding to the “current_score” as a counterfactual vector that would be used to generate recommendations for a user.

The value “current_delta” is the difference between the current cost for the current intermediate vector and a previous cost for a previous vector. For example, the current cost may be “3”, indicating that three input features have been changed to counterfactual features for the current intermediate vector, and the previous cost may be “2”, indicating that two input features were changed to counterfactual features for the previous intermediate vector.

In Equation 1,

$$( \frac{\vert goal\_score - current\_score \vert}{current\_delta} )$$

is a part of the heuristic that estimates the remaining number of changes that are left until the output score will reach the selected class. For example, when

$$( \frac{\vert goal\_score - current\_score \vert}{current\_delta} ) = 2.0349 … ,$$

then it is estimated that at least two more changes will be made to the input vector (i.e., two more replacements of input features with counterfactual features) before an intermediate vector that achieves the “goal_score” is found.

$$( \frac{lambda * depth}{num\_features} )$$

is a part of the equation controlled by “lambda”. When the heuristic is not expected to be correct (e.g., when few changes have been made to the input vector (i.e., the “depth” is low)) and there is a high variance in the changes to the scores of intermediate vectors (e.g., greater than 10% change in the scores between intermediate vectors corresponding to intermediate nodes connected by an edge in a graph).

In one embodiment, the counterfactual vector is searched for by processing, with the model, an intermediate vector to generate the intermediate score. N intermediate vector is generated by replacing in input feature with a counterfactual feature. The intermediate vector is then processed with the model to generate an intermediate score for the intermediate vector. The intermediate score may be compared to a threshold to determine if the intermediate score is part of a selected class. For example, the selected class may be for scores that satisfy (e.g., are above) the threshold.

In one embodiment, the counterfactual vector is searched for by determining the cost value from a number of features changed between the input vector and the intermediate vector. The cost value may be determined by counting the number of features changed from input features to counterfactual features, by counting the number of edges between an intermediate node corresponding to the intermediate vector and a root node corresponding to an input vector, etc.

In one embodiment, the counterfactual vector is searched for by determining the heuristic value using the intermediate score. As described above, Equation 1 may be used to determine the heuristic value. After determining the cost and heuristic for the leaf nodes of a tree formed by a graph used to search for a counterfactual vector, the system may expand the leaf node having the lowest combination of cost and heuristic values, e.g., the lowest total of the cost plus the heuristic for that node.

In one embodiment, the one or more input features from the input vector are replaced with the one or more counterfactual features in which the one or more counterfactual features are determined from a subset of a data set. The subset may correspond to the selected class. The subset of the data set may include training input vectors from training data in which the scores of the training input vectors are to the selected class. In one embodiment, a counterfactual feature may be a mean value for a numerical input feature from a set of training data. In one embodiment, a counterfactual feature may be a mode value for a categorical input feature from a set of training data.

In one embodiment, the heuristic value is determined using in intermediate score and a previous score to predict a remaining number of features to change between the input vector and the counterfactual vector. The previous score is the score for a previous vector, which may correspond to the root node or to an intermediate node. The previous vector may have fewer changes to the input vector as compared to the intermediate vector.

In one embodiment, the counterfactual vector is searched for using a graph. The nodes of the graph may correspond to intermediate vectors. The intermediate vectors are tested against a threshold and an intermediate vector that satisfies the threshold (e.g., is above or below the threshold) may be identified as a counterfactual vector. The input vector may correspond to a root node (a node with no parent nodes) of the graph and the counterfactual vector may correspond to a leaf node (a node with no child nodes) of the graph. The graph may be a directed graph that is acyclic and forms a tree data structure.

At Step 210, one or more recommendations are presented using the counterfactual vector. In one embodiment, the recommendations are presented by selecting recommendation text that corresponds to the input features that were changed in the input vector, transmitting the recommendation text to a user application, and displaying the recommendation text on a user interface by the user application. The first input feature changed may correspond with the first or highest ranked recommendation displayed to a user.

In one embodiment, a graph is used to search for the counterfactual vector. With the graph, a path from the root node (of the input vector) to the leaf node (of the counterfactual vector) may be used to select the recommendation presented to a user. In one embodiment, each edge in the graph corresponds to a change to an input feature of the input vector and also to corresponding recommendation text. The recommendation text for the edge closest (and including) to the root node may be presented as the first recommendation. In one embodiment, additional recommendations are presented in the order of the corresponding edges in the path of the graph from the node of the input vector to the node of the counterfactual vector.

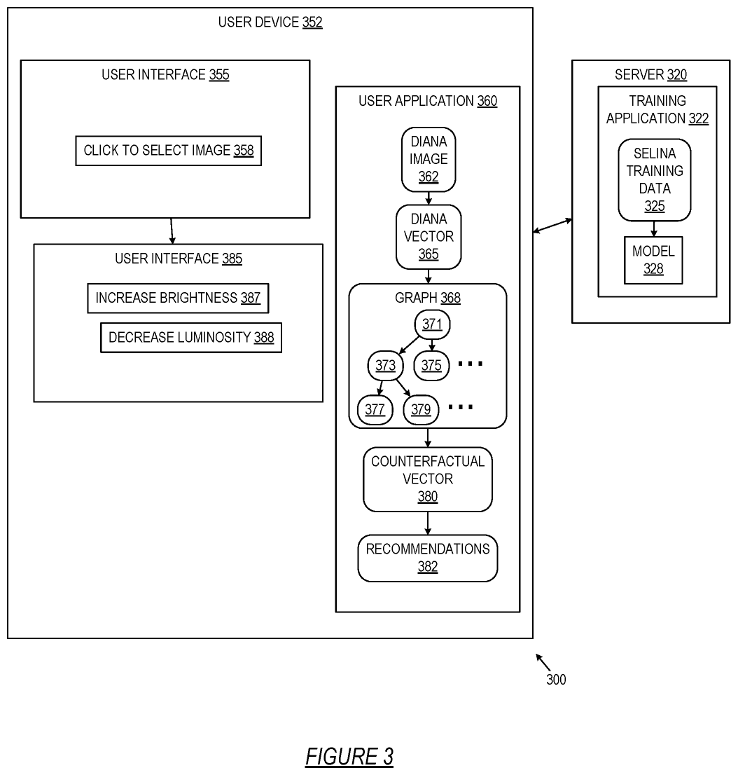

Turning to FIG. 3, the system (300) processes images to provide recommendations to improve images. Wonder Woman sees that her recent selfie images (including the Wonder Woman image (362)) are not get as many likes as Catwoman's recent selfie images. Wonder Woman decides to call on Spiderman for help since Spiderman's selfies seem so professionally done, almost as if there were more than meets the eye for Spiderman's secret identity as a photographer. Spiderman, elated to earn some side income uses the system (300).

Spiderman logs into the server (320) to run the training application (322) on the Catwoman training data (325). The Catwoman training data (325) includes a large selection of social media images (including those by Catwoman and others) that are labeled with the number of likes for each image. The model (328) is trained to extract input features from the Catwoman training data (325) and predict the labels (number of likes) using a machine learning model. The input features for one image forms an input vector from which a score (in this case, a predicted number of likes) is generated by the model (328).

After training the model (328), Spiderman develops an app (the user application (360)) for Wonder Woman to use to check her selfies before posting. Wonder Woman opens the user application (360), which displays the user interface (355).

The user interface (355) includes the button (358). Selection of the button (358) prompts Wonder Woman to select the Wonder Woman image (362), which is then processed.

The Wonder Woman image (362) is processed by the model (328) to generate the Wonder Woman vector (365) and a score for the Wonder Woman vector (365), which does not satisfy a threshold, i.e., the predicted number of likes is below a threshold value. The model (328) may be downloaded to and executed on the user device (352). Wonder Woman may set the threshold to a specific number or a default number may be used. The default may be the average number of likes for the images from the Catwoman training data (325).

After determining the score of the Wonder Woman vector (365) is too low (i.e., below the threshold), the user application (360) searches for the counterfactual vector (380) using the graph (368). The root node (371) corresponds to the Wonder Woman vector (365). The user application (360) expands on the root node (371) by calculating scores, costs, and heuristic values for the intermediate nodes (373), (375), . . . , which each include an edge with the root node (371). None of the scores meet the threshold and the user application (360) expands the intermediate node (373) after determining that the intermediate node (373) has the lowest cost plus heuristic values. The user application (360) expands the intermediate node (373) by calculating scores, costs, and heuristic values for the intermediate nodes (377), (379), . . . , which each include an edge with the intermediate node (373). The score for the intermediate node (379) (calculated with the model (328)) is identified as meeting the threshold and is the counterfactual vector (380).

The counterfactual vector (380) includes two changes from the Wonder Woman vector (365), i.e., two of the input features from the Wonder Woman vector (365) were changed to counterfactual features in the counterfactual vector (380). The recommendations (382) are identified from the changes between the Wonder Woman vector (365) and the counterfactual vector (380).

The user application (360) updates the user interface (355) to the user interface (385) to include the recommendations (382) as the recommendation text (387) and (388). The recommendation text (387) corresponds to the edge between the nodes (371) and (373) of the graph (368) and indicates that increasing the brightness may improve the number of likes for the Wonder Woman image (362). The recommendation text (388) corresponds to the edge between the nodes (373) and (379) of the graph (368) and indicates that decreasing the luminosity may improve the number of likes for the Wonder Woman image (362).

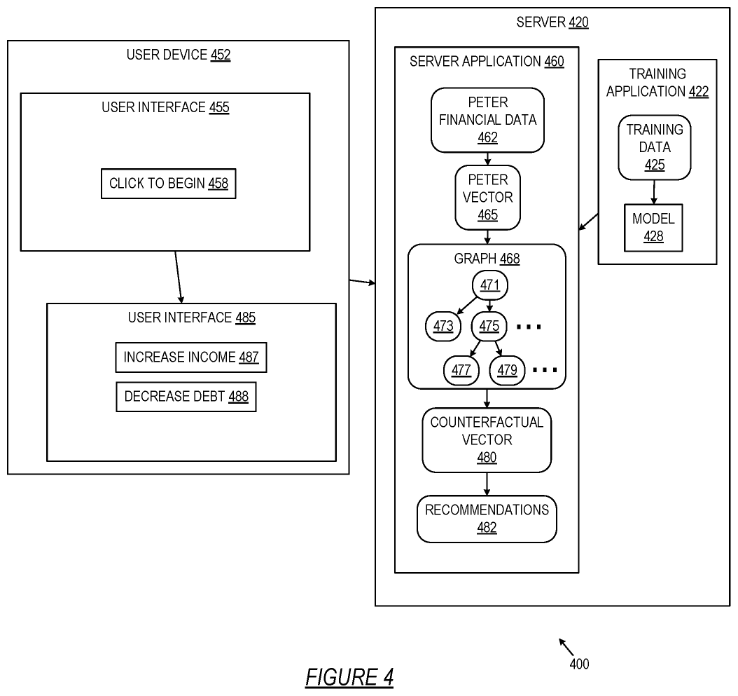

Turning to FIG. 4, the system (400) processes financial data to provide recommendations to improve applications. Flush with cash after helping Wonder Woman, Spiderman decides to buy Aunt May a house. Unfortunately, the application gets denied and Spiderman ponders whether to continue fighting crime. Fortunately, recommendations are provided using the system (400).

The company processing the application operates the server (420), which is used to train the model (428). The training application (422) trains the model (428) on the training data (425). The training data (425) includes a large selection of financial data for multiple people that have electronically submitted applications to the company. The records of the applications are labeled as “denied”, “approved in arrears”, and “approved in good standing”. The model (428) is trained to extract input features from the training data (425) and predict the labels using a machine learning model that forms part of the model (428). The input features for set of financial data forms an input vector from which a score (in this case, a predicted categorical value) is generated by the model (428). The company exposes a website that users may log into, which provides access to the server application (460), which utilizes the model (428).

Spiderman uses his smartphone to access the server application (460) through the user interface (455). The user interface (455) includes the button (458). Selection of the button (458) prompts Spiderman to upload or otherwise allow access to the Spiderman financial data (462), which is then processed.

The Spiderman financial data (462) is processed by the model (428) to generate the Spiderman vector (465) and a score for the Spiderman vector (465), which does not satisfy a threshold, e.g., is not to the selected class of “approved in good standing”. The model (428) is executed on the server (420), which helps to limit the risk of hacking by supervillains. The identification (i.e., the threshold) for which category of output from the model (428) corresponds to a selected class may be predefined. For example, the category of “approved in good standing” may be the selected category.

After determining the score of the Spiderman vector (465) is not to the selected class, the server application (460) searches for the counterfactual vector (480) using the graph (468). The root node (471) corresponds to the Spiderman vector (465). The server application (460) expands on the root node (471) by calculating scores, costs, and heuristic values for the intermediate nodes (473), (475), . . . , which each include an edge with the root node (471). None of the scores meet the threshold and the server application (460) expands the intermediate node (475) after determining that the intermediate node (475) has the lowest cost plus heuristic values. The server application (460) expands the intermediate node (475) by calculating scores, costs, and heuristic values for the intermediate nodes (477), (479), . . . , which each include an edge with the intermediate node (475). The score for the intermediate node (477) (calculated with the model (428)) is identified as meeting the threshold and is the counterfactual vector (480).

The counterfactual vector (480) includes two changes from the Spiderman vector (465), i.e., two of the input features from the Spiderman vector (465) were changed to counterfactual features in the counterfactual vector (480). The recommendations (482) are identified from the changes between the Spiderman vector (465) and the counterfactual vector (480).

The user interface (455) is updated to the user interface (485) to include the recommendations (482) as the recommendation text (487) and (488) after processing the application submitted using the user device (452). The recommendation text (487) corresponds to the edge between the nodes (471) and (475) of the graph (468) and indicates that increasing the recorded amount of income may improve the outcome of an application to be approved. The recommendation text (488) corresponds to the edge between the nodes (475) and (477) of the graph (468) and indicates that decreasing the amount of debt of the user may improve the outcome of the application.

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 5A, the computing system (500) may include one or more computer processors (502), non-persistent storage (504), persistent storage (506), a communication interface (512) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) may be one or more cores or micro-cores of a processor. The computer processor(s) (502) includes one or more processors. The one or more processors may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (508). The inputs may include text input, audio input, video input, etc., which may be processed and transmitted by the computing system (500) in accordance with the disclosure. The communication interface (512) may include an integrated circuit for connecting the computing system (500) to a network (not shown) (e.g., a local area network (LAN), a wide area network (WAN) such as the Internet, mobile network, or any other type of network) and/or to another device, such as another computing device.

Further, the output device(s) (508) may include a display device, a printer, external storage, or any other output device. One or more of the output devices may be the same or different from the input device(s). The input and output device(s) may be locally or remotely connected to the computer processor(s) (502). Many different types of computing systems exist, and the aforementioned input and output device(s) may take other forms. The output device(s) (508) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention, which may include transmitting, receiving, presenting, and displaying data and messages described in the other figures of the disclosure.

The computing system (500) in FIG. 5A may be connected to or be a part of a network. For example, as shown in FIG. 5B, the network (520) may include multiple nodes (e.g., node X (522), node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522), node Y (524)) in the network (520) may be configured to provide services for a client device (526), including receiving requests and transmitting responses to the client device (526). For example, the nodes may be part of a cloud computing system. The client device (526) may be a computing system, such as the computing system shown in FIG. 5A. Further, the client device (526) may include and/or perform all or a portion of one or more embodiments of the invention.

The computing system of FIG. 5A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

1. A method, comprising:
receiving an input vector generated by a machine learning model, comprising a plurality of input features;
applying a neural network model to the input vector to generate a score, wherein the score of the input vector is not to a selected class;
applying a search algorithm to the input vector using a cost value and a heuristic value to generate a counterfactual vector,
wherein the search algorithm directly replaces one or more input features of the input vector with one or more counterfactual features to generate the counterfactual vector,
wherein the counterfactual vector corresponds to a counterfactual score to the selected class,
wherein the search algorithm determines the heuristic value for an intermediate vector using a selected class score, of the selected class, and an intermediate score, of the intermediate vector, and
wherein the heuristic value predicts a remaining number of features to change between the intermediate vector and the counterfactual vector; and
presenting one or more recommendations using the counterfactual vector.

2. The method of claim 1, further comprising:
searching for the counterfactual vector, wherein the searching comprises:
processing, with the neural network model, the intermediate vector to generate the intermediate score;
determining the cost value from a number of features changed between the input vector and the intermediate vector; and
determining the heuristic value using the intermediate score.

3. The method of claim 1, further comprising:
processing, with the neural network model, the input vector, wherein the neural network model is trained by:
processing, with the neural network model, training input to generate training output; and
processing the training output to update the neural network model to improve a characteristic of the neural network model.

4. (canceled)

5. The method of claim 1, further comprising:
replacing the one or more input features from the input vector with the one or more counterfactual features, wherein the one or more counterfactual features are determined from a subset of a data set and wherein the subset corresponds to the selected class.

6. The method of claim 1, further comprising:
replacing the one or more input features from the input vector with the one or more counterfactual features, wherein a counterfactual feature, of the one or more counterfactual features, comprise a mean for a numerical feature of the one or more input features of the input vector.

7. The method of claim 1, further comprising:
replacing the one or more input features from the input vector with the one or more counterfactual features, wherein a counterfactual feature, of the one or more counterfactual features, comprises a mode for a categorical feature of the one or more input features of the input vector.

8. (canceled)

9. The method of claim 1, further comprising:
searching for the counterfactual vector using a graph, wherein a plurality of nodes of the graph correspond to a plurality of intermediate vectors, and wherein the plurality of intermediate vectors comprises the counterfactual vector.

10. The method of claim 1, further comprising:
searching for the counterfactual vector using a graph, wherein the input vector corresponds to a root node of the graph and wherein the counterfactual vector corresponds to a leaf node of the graph.

11. The method of claim 1, further comprising:
searching for the counterfactual vector using a graph; and
presenting the one or more recommendations using a path from the graph.

12. A system comprising:
a processor;
a counterfactual controller configured to search for a counterfactual vector;
a recommendation controller configured to present one or more recommendations;
an application executing on one or more servers and configured for:
receiving an input vector generated by a machine learning model, comprising a plurality of input features;
applying a neural network model to the input vector to generate a score, wherein the score of the input vector is not to a selected class;
applying a search algorithm to the input vector using a cost value and a heuristic value to generate the counterfactual vector,
wherein the search algorithm directly replaces one or more input features of the input vector with one or more counterfactual features to generate the counterfactual vector,
wherein the counterfactual vector corresponds to a counterfactual score to the selected class, and
wherein the search algorithm determines the heuristic value for an intermediate vector using a selected class score, of the selected class, and an intermediate score, of the intermediate vector,
wherein the heuristic value predicts a remaining number of features to change between the intermediate vector and the counterfactual vector; and
presenting, with the recommendation controller, the one or more recommendations using the counterfactual vector.

13. The system of claim 12, wherein the application is further configured for:
searching for the counterfactual vector, wherein the searching comprises:
processing, with the neural network model, the intermediate vector to generate the intermediate score;
determining the cost value from a number of features changed between the input vector and the intermediate vector; and
determining the heuristic value using the intermediate score.

14. The system of claim 12, wherein the application is further configured for:
processing, with the neural network model, the input vector, wherein the neural network model is trained by:
processing, with the neural network model, training input to generate training output; and
processing the training output to update the neural network model to improve a characteristic of the neural network model.

15. (canceled)

16. The system of claim 12, wherein the application is further configured for:
replacing the one or more input features from the input vector with the one or more counterfactual features, wherein the one or more counterfactual features are determined from a subset of a data set and wherein the subset corresponds to the selected class.

17. The system of claim 12, wherein the application is further configured for:
replacing the one or more input features from the input vector with the one or more counterfactual features, wherein a counterfactual feature, of the one or more counterfactual features, comprise a mean for a numerical feature of the one or more input features of the input vector.

18. The system of claim 12, wherein the application is further configured for:
replacing the one or more input features from the input vector with the one or more counterfactual features, wherein a counterfactual feature, of the one or more counterfactual features, comprises a mode for a categorical feature of the one or more input features of the input vector.

19. (canceled)

20. A method comprising:
transmitting a request;
receiving a response to the request, wherein the response is generated by:
applying a neural network model to an input vector to generate a score, wherein the score of the input vector is not to a selected class, the input vector generated by a machine learning model;
applying a search algorithm to the input vector using a cost value and a heuristic value to generate a counterfactual vector,
wherein the search algorithm directly replaces one or more input features of the input vector with one or more counterfactual features to generate the counterfactual vector,
wherein the counterfactual vector corresponds to a counterfactual score to the selected class, and
wherein the search algorithm determines the heuristic value for an intermediate vector using a selected class score, of the selected class, and an intermediate score, of the intermediate vector,
wherein the heuristic value predicts a remaining number of features to change between the intermediate vector and the counterfactual vector; and
presenting one or more recommendations using the counterfactual vector;
displaying the response comprising the one or more recommendations.
